(19) United States
(12) Patent Application Publication
(10) Pub. No.: US 2020/0066174 A1
(43) Pub. Date: Feb. 27, 2020

(54) Read Write Communicate Education Tool

(71) Applicant: Harald John Torgesen, III, West Columbia, SC (US)

(72) Inventor: Harald John Torgesen, III, West Columbia, SC (US)

(21) Appl. No.: 16/108,513

(22) Filed: Aug. 22, 2018

(51) Int. Cl. G09B 7/02; G06K 9/00

(52) U.S. Cl. CPC G09B 7/02; G06K 2209/01; G06K 9/00463

(57) ABSTRACT

The present invention is an educational tool to assist educators to assess and monitor the progress of writing proficiency of their students. Educators upload student's writing examples onto the website for analysis by one or more Readability Assessment Algorithms. Hand-written examples are converted to text prior to the analysis by using Optical Character Recognition (OCR) software.

### CROSS REFERENCE TO RELATED APPLICATIONS

Not Applicable

### STATEMENT REGARDING FEDERALLY SPONSORED RESEARCH OR DEVELOPMENT

This invention was not made by an agency of the United States Government nor under a contract with an agency of the United States Government.

### THE NAME OF THE PARTIES TO JOINT RESEARCH AGREEMENT

Not Applicable.

### INCORPORATION BY REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable

### BACKGROUND OF THE INVENTION

### Field of the Invention

The present invention is an educational tool to assist educators to assess and monitor the progress of writing proficiency of their students. Educators will be able to use the real time and historical assessment of students writing proficiency to modify instruction plans to address weaknesses in the student's writing skills.

Literacy is a key factor to individual and societal economic success in our increasing technology driven global economy. Countries with a higher percentage of adults with low literacy proficiency have a slower GDP growth rate (Literacy Foundation). Individuals with lower literacy proficiency have lower income and higher unemployment rates (Literacy Foundation).

Illiteracy also impacts an individual's health as illiterate individuals have more workplace accidents, take longer to recover and more often misuse medication because of the inability to read and understand relevant instructions. (Literacy Foundation)

The National Report Card from the United States Department of Education shows that improvements in reading skills is improving only very slowly over the last ten years. The percentage of fourth graders showing a basic level or above in reading skills has only increased 1% between 2007 and 2017; 67% and 68% respectively. The percentage of eight graders showing a basic level or above in reading skills has increased 2% between 2007 and 2017; 74% and 76% respectively.

It is well established that reading skills are directly related to writing skills and both are directly related to oral communication skills and mathematic skills. Improvement in a student's writing skills would lead to improvement in other areas; reading, oral communication and mathematics.

The present invention a tool for teachers to assess a student's writing skills and monitor the student's improvement. The invention allows a teacher to upload a student's writing sample, this sample can be either hand written or typed. If hand written, the invention translates the written document into text. The sample is then analyzed using one or more readability algorithms and the results are provided to the educator.

### Description of Related Art

The Selective Writing Assessment With Tutoring (U.S. Pat. No. 8,608,477 issued Dec. 17, 2013 to Maguire et al.) describes an on-line system that provides a writing assessment with instructional feedback. This invention requires the student to write an essay on-line in response to an assignment provided by the invention. The Maguire invention analyzes the essay and provides feedback to the writer.

The System and Method for Automated Literacy Assessment (Patent Application Publication US 2018/0158359, Quinlan) describes a literacy assessment tool that evaluates the user's reading and writing ability. Reading ability is evaluated by monitoring the user's progression through on-line text using an eye-tracking device and/or display movement or by the user reading out loud with the invention checking the accuracy of the spoken word to the written text.

The Quinlan invention evaluates writing by having the user write a document on-line with the system evaluating whether the characters typed constitute words, latency in the progression of the writing and the user's spelling accuracy.

Both the Maguire and Quinlan invention provide feedback to the user post completion of the analysis. The Maguire invention can also provide feedback to the user while the user is writing the essay.

### BRIEF SUMMARY OF THE INVENTION

The present invention is an educational tool to assist educators to assess and monitor the progress of writing proficiency of their students. Educators will be able to use the real time and historical assessment of students writing proficiency to modify instruction plans to address weaknesses in the student's writing skills.

The educator interfaces with the invention by means of a website. The educator registers the student by providing the state, school district, school, assigned grade level, class and student name or unique id. The educator then uploads the student's writing example into the website. The example may be either hand-written or typed. A hand-written document is converted to text using Optical Character Recognition (OCR) software. The document is then analyzed using one or more Readability Assessment Algorithms. Results of the analysis are reported to the educator.

Multiple examples of a student's writing can be uploaded into the system during one or more website sessions. The invention stores the analysis data from each writing sample and provide results showing the student's progression over time. Educators can also access data on writing proficiency for a class, assigned grade level at the level of a particular school, school district or state.

### BRIEF DESCRIPTION OF THE SEVERAL VIEWS OF THE DRAWING

FIG. 1 is a flowchart of the invention showing the major steps of the method.

FIG. 2 is a depiction of the system and teacher interface.

### DETAILED DESCRIPTION OF THE INVENTION

The invention disclosed in this application is a system and method for assessing a student's writing proficiency using documents written by the student. The invention is an educational tool to assist educators to assess and monitor the progress of writing proficiency of their students. The system and method objectives are realized in a software-implemented, computerized, on-line application.

The educator interfaces with the invention by means of a website. The educator registers the student by providing information including but not limited to the state, school district, school and the student's name or unique id. The educator uploads the student's writing example into the website. The example may be either hand-written or typed. A hand-written document is converted to text using Optical Character Recognition (OCR) software.

Software portion of the invention determines the number of characters, words, syllables and sentences in the uploaded writing sample. These numbers are then used with one or more Readability Assessment Algorithms to evaluate the document. There are many Readability Assessment Algorithms currently existing that can be utilized in this invention. These assessment methods include, but are not limited to, the following:
Flesch-Kincaid Readability Tests
Linsear Write Readability Formula
Automated Readability Index
Coleman-Liau Readability Formula
Powers-Sumner-Kearl Readability Formula
Dale-Chall Readability Formula
Bormuth Grade Level Formula
SMOG Formula

The Flesch-Kincaid Readability Tests are comprised of two separate tests, the Flesch Reading Ease and the Flesch-Kincaid Grade Level. The tests are widely used in the field of education. Both tests utilize the total number of words, syllables and sentences to determine the readability level of the document.

Flesch Reading Ease=206.835−1.015×(TW÷TSe)−84.6(TSy÷TW)

Flesch-Kincaid Grade Level=0.39×(TW÷Tse)+11.8×(TSy÷TW)−15.59
Where TW is total number of words, TSe is total number of sentences and TSy is the total number of syllables. The Flesch Reading Ease score is interpreted using a table that relates the score to a reading grade level ranging from fifth grade to a college graduate. The Flesch-Kincaid Grade Level algorithm directly calculates the grade level readability of the document.

The Linsear Write Readability Formula uses a 100 word sample from the document to calculate the corresponding United States grade level. It requires the determination of the number of sentences, the number of words of two syllables or less (easy words) and the number of words of three syllables or more (hard words).

Initial Score=(EW+(3×HW))÷TSe
Where EW is the number of easy words, HW is the number of hard words and TSe is the total number of sentences in the 100 word sample of the document. If Initial Score is greater than 20, the grade level is determined by dividing the Initial Score by 2. If the Initial Score is 20 or less, subtract two from the Initial Score and then divide by 2 to determine the grade level.

The Automated Readability Index like the previous readability algorithms also uses the number of words and sentences in the document but uses characters instead of syllables.

Automated Score=4.71×(TC÷TW)+0.5×(TW÷TSe)−21.43
Where TC is the total number of characters (letters and numbers), TW is the total number of words and TSe is the total number of sentences. The Automated Score is interpreted using a table that relates the Automated Score to readability grade level from kindergarten to college.

The Coleman-Liau Readability Formula directly calculate the grade level of the document from number of letters, words and sentences.

Coleman-Liau Score=0.0588×((TL÷TW)×100)−0.296×((TSe÷TW)×100)−15.8
Where TL is the total number of letters, TW is the total number of words and TSe is the total number of sentences.

The Powers-Sumner-Kearl (PSK) Readability Formula is considered suitable for primary age children (7-10 years old). It directly calculates the grade level and reading age using the number of words, sentences and syllables in the document.

PSK Grade Level=0.0778×(TW÷TSe)+0.455×TSy−2.2029

PSK Reading Age=0.0778×(TW÷TSe)+0.455×TSy+2.7971
Where TW is total number of words, TSe is the total number of sentences and TSy is the total number of syllables in the document.

The Dale-Chall Readability incorporates the difficulty level of the word into the algorithm in addition to the number of words and sentences to evaluate the reading level. The Dale-Chall test uses a list of 3,000 words that are considered to be familiar to 80% of fourth-grade students, words used in this document that are not on this 3,000 word list are deemed as “difficult” words.

Raw Score=0.1579((DW÷TW)×100)+0.0496(TW÷TSe)
Where DW is the number of difficult words, TW is the total number of words and TSe is the total number of sentences. If DW÷TW is above 5% then add 3.6365 to the Raw Score to obtain the Dale-Chall Score, otherwise the Dale-Chall Score is equal to the Raw Score. The Dale-Chall Score is interpreted utilizing a table that relates the score to readability levels from fifth grade to college.

The Bormuth Grade Level (BGL) Formula uses the number of characters, words and sentences along with the Dale-Chall List of 3,000 familiar words to determine the grade level readability of a document.

BGL=0.886593−((TC÷TW)×0.03640)+((FW÷TW)×0.161911)−((TW÷TSe)×0.21401)−((TW÷TSe)×0.000577)−((TW÷TSe)×0.000005)
Where FW is the number of words in the document found on the Dale-Chall List of 3,000 familiar words, TC is the total number of characters, TW is the total number of words and TSe is the total number of sentences.

The SMOG Formula uses the number of sentences and words with three or more syllables to estimate the grade level readability of a document. The SMOG Formula requires the writing sample to have at least 30 sentences.

SQUARE=square root of(PS=(30÷TSe))

SMOG Grade=1.0430×(SQUARE)+3.1291
Where PS is the number of words with three or more syllables and TSe is the total number of sentences.

The invention reports and stores the algorithm score for the student whose writing sample was analyzed. The invention can store multiple writing sample scores for an individual student and for multiple students. Thus, data can be compiled for a class, school or school district.

An example of usage of the invention would be the teacher who registers each member of her 6^{th} grade class. She then uploads one or more examples of a written assignment for each student from the beginning of the school term. The invention converts any hand-written examples to text using the OCR software. The invention then analyzes the readability of each writing sample using one or more Readability Assessment Algorithms. Upon completion of the readability analysis the teacher can then access the results for each member of her class and has a baseline for each student. Then over the course of the school term, the teacher can upload additional student writing samples and establish a level of progression or lack thereof for each student. The teacher can utilize this data to modify lesson plans and identify students who need additional attention.

Education administrators can utilize the invention to access data for a assigned grade level on an individual school, school district or even state wide level to evaluate the literacy level of a particular grade. This data could then be used to assist in the allocation of funds, determination of best practices or other practices to improve the literacy level of the students in their district or state.

The invention disclosed in this application has significant differences from the Maguire invention. The Maguire invention requires the student to write an essay on-line in response to a provided assignment, while the present invention is capable of utilizing routine school-work assignments that may be handwritten or typed and are uploaded into the system via a pdf or the like. The present invention only requires the teacher to access the system, who is then able to upload writing samples for single or multiple students. Using the present invention, the teacher is able to obtain readability scores for multiple students with only one computer interface. The Maguire invention would require either multiple interfaces for each individual student to input their response to the invention's assignment or would take a significant period of time for the students to take turns if few computers were available.

The Maguire invention also requires the student to be able to use a computer and type, which would limit the use of the invention to age groups that have the capability to type. The present invention can utilize hand-written examples of writing by converting them to text via OCR software.

The Quinlan invention access reading ability by evaluating the user's progression through on-line text using an eye-tracking device and/or display movement or by the user reading out loud with the invention checking the accuracy of the spoken word to the written text.

The Quinlan invention evaluates writing by having the user write a document on-line with the system evaluating whether the characters typed constitute words, latency in the progression of the writing and the user's spelling accuracy. The Quinlan invention, like the Maguire invention, differs from the present invention by requiring the student to submit their writing sample by typing on-line. The Quinlan invention does not use a recognized Readability Assessment Algorithms as does the present invention.

The Maguire and Quinlan inventions are designed to provide an analysis to a single user. The present invention, while having this same capability, is also able to store data and provide literacy level data on an individual, class or assigned grade level on a school, school district or state-wide level.

A potential patent classification for this invention include Class 434 Education and Demonstration, Subclass 156 Language.

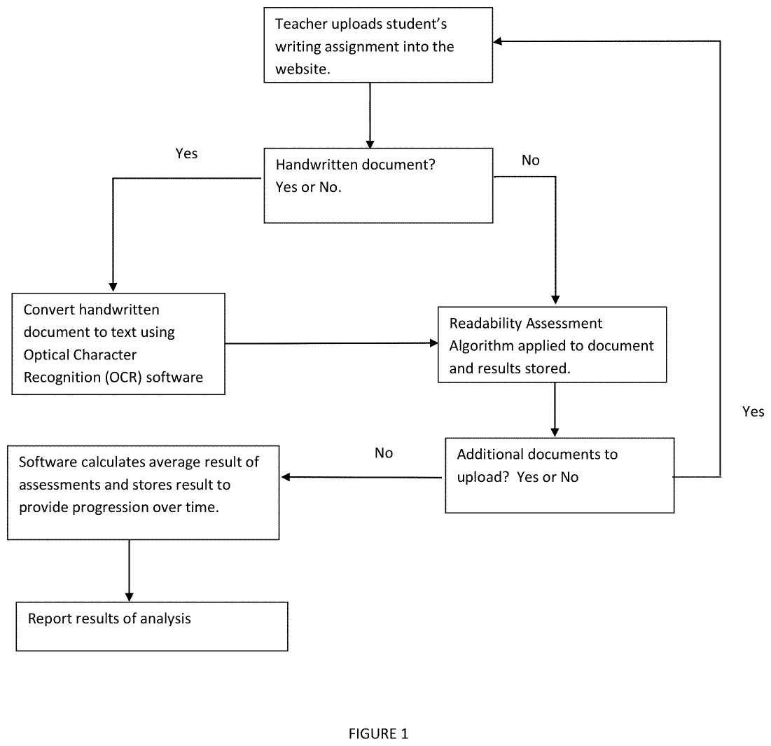

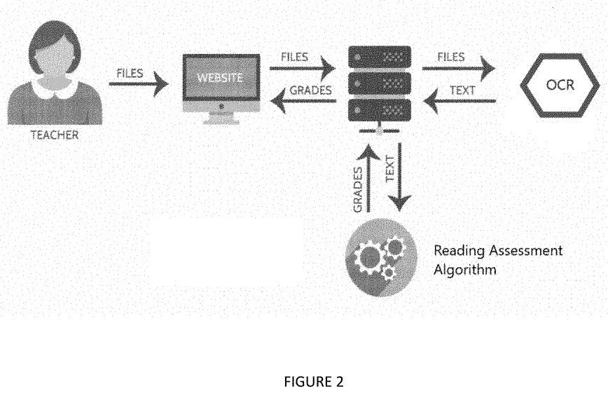

The present invention described above and illustrated in FIGS. 1 through 2 is visualized as the preferred embodiment of the invention. It is envisioned that this invention may be embodied in many different forms and should not be construed as limited to the embodiments set forth herein. It will be understood by those skilled in the art that changes in forms and details may be made without departing from the spirit and scope of the present application. It is therefore intended that the present invention not be limited to the exact forms and details described and illustrated herein but falls within the scope of the appended claims.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The invention claimed is:

1. A process for monitoring, scoring and providing feedback on written text, the process comprising: registration of a student by a user, written document input from said user by means of document upload; analysis of said document text, by a processor, utilizing a Readability Assessment Algorithms; and providing the score from said Readability Assessment Algorithms to the user.

2. The process of claim 1 further comprising, conversion of a hand-written document into text using Optical Character Recognition.

3. The process of claim 1, where said Readability Assessment Algorithms is comprised of one or more of the following methods:
Flesch-Kincaid Readability Tests
Linsear Write Readability Formula
Automated Readability Index
Coleman-Liau Readability Formula
Powers-Sumner-Kearl Readability Formula
Dale-Chall Readability Formula
Bormuth Grade Level Formula
SMOG Formula

4. The process of claim 1 further comprising, program code for the storage of the Readability Assessment Algorithms score data and analysis of the stored data for providing feedback of said scores on a school, school district or state level.
